(19) United States
(12) Patent Application Publication
(10) Pub. No.: US 2017/0270273 A1
(43) Pub. Date: Sep. 21, 2017

(54) Application for Informing Physicians and Patients of Tapered Medical Doses

(71) Applicants: Michael Garner, Boone, NC (US); Philip Guilford, Greer, SC (US)

(72) Inventors: Michael Garner, Boone, NC (US); Philip Guilford, Greer, SC (US)

(21) Appl. No.: 15/072,329

(22) Filed: Mar. 16, 2016

(51) Int. Cl. G06F 19/00

(52) U.S. Cl. CPC G06F 19/3456

(57) ABSTRACT

Process for the computer generation of prescribing information, and printable calendar, for a medicinal drug taper (escalating or deescalating). This process allows the user, generally a practicing physician, to use an application on a variety of different platforms. This is useful in any medication in which the dosage must be escalated or de-escalated. This is perhaps most common with respect to steroid prescriptions, wherein the physician prescribes dosages that steadily decrease over time, especially if the patient has been on the steroids for an extended period of time. The application also gives physicians the option to increment dosage over time, and ultimate control over when the daily doses are determined. The calculation and dosing calendar will be available to the physician, patient, any attending nurse, and any prescribing pharmacist.

### SUMMARY OF THE INVENTION

### BRIEF DESCRIPTION OF THE INVENTION

In order to overcome needless time and money lost due to the hand writing of prescription taper calendars, we do present this tapering application.

The invention accordingly comprises a web application, subsequently known as application, capable of carrying out the following steps. Creating a graphical user interface, GUI, which is displayed to the user, and serves as the primary method of interacting with the application. The application will be ported to all popular desktop and mobile operating systems without relying on internet connectivity for its function. Updates to the application software will require an internet connection. The user will select their preferred tapering method, input the parameters of the drug taper including name of the medication, the preferred sizes/denominations/units of the written prescription, the date the patient should start taking the medication, other parameters specific to the preferred tapering method, and then submit the parameters to the application for processing. The application will accept, validate, and process the parameters selected by the user, and then output the results through the GUI for the user to view. Results processed, displayed, and made available, through various modiums, to the user by the application will include, but are not limited to a stepwise representation of the taper parameters, the prescribing sizes and totals of the prescribing sizes to be tapered, and a calendar with the daily administration dose, constrained by the prescribing sizes selected by the user, needed to adhere to the medicinal drug taper. This calendar will be available for the user to print and/or download in various formats including the Portable Document Format, and also those accepted by popular calendar applications. The calendar can then be made available to the patient to facilitate medication adherence. The quantitation will occur automatically to output the amount of the medicine prescribed based on the specified phase dose and selected pill sizes in order to optimize the combination of both number of pills prescribed as well as the number of pills that must be split in half to achieve a half dose of a specified pill size. This is due to the fact that oral prescriptions are on certain occasions administered via the half pill size. For example, if a phase of a taper requires the patient to take 5 milligrams of a medication, but the user selected only the 10 milligram size from the sizes available for prescribing, then the output from the application will reflect the desired parameters on the calendar to show that the 10 milligram pill should be physically divided in half, and the patient should take half of a 10 milligram pill, or 5 milligrams of medication. The program, including the steps it takes from the entry of inputs into the release of the taper calendar, will be presented in the detailed description below

### Definitions, Terms, Elements

Taper—A medicinal regimen whose dosage varies over time until it ends. In classic medical practice, this change was strictly a decrease in dosage but occasionally in modern practice, the word taper includes medicinal dosages that are flexible with respect to whether they increment, decrement, or both over time. Any drug can be prescribed as a taper.

Linear Taper—a taper that varies medicinal administration by regular quantities and temporal moments

Non-linear (Regular) Taper—taper that varies medicinal administration by amounts as controlled by the prescriber and in quantities controlled by the prescriber in each discrete time phase

Electronic Medical Record (EMR)—System medical care providers use to maintain patient files electronically

Phase panel—In this invention, a graphical panel where all the inputs a user must supply for a single temporal phase of medicinal administration are located

### BACKGROUND OF THE INVENTION

The practice of medicine requires that medicine be administered in varying doses due to many factors, including differences in individual patients and differences in medicine required at different stages of the sickness. Furthermore, some medications, such as corticosteroids (perhaps the most commonly tapered medication class), suppress the body's ability to produce its own biologic steroids. This is one of the factors that creates the physiologic necessity to taper these medications. Other reasons for tapering medications include physical dependence as well as the tolerability of side effects. This necessitates that physicians prescribe medicine that varies in its dosage over time. As such, with respect to corticosteroids which will be used as the example, the medicine incrementally decreases in dosage in these situations. Because medicine tapers off during the course of an administration time frame, prescriptions that taper off are referred to as tapers. Currently, physicians that are prescribing tapered medication are often having to handwrite the taper calendars or use stickers on a calendar to create a schedule for the patient to take their tapered medication, a process that costs them time needlessly. Doing the algebra by hand to figure out the prescription sizes and taper calendar is a needless waste of the value resource that is the physician's clinical mind. Furthermore, variability of human handwriting and limited space requirements on current taper calendars hamper the capacity of physicians to deliver clear written instructions to patients about the taper and how it will function. This time lost could be better spent with patients, enabling additional physician flexibility. Maximizing physician time with patients has value in the provision of medical services at a time in which the demands on physician time far exceed the supply of physician time. Furthermore, in some specialties, physician pay is linked to the number of patients the physician sees. Therefore, physicians themselves would also benefit by saving time wasted doing needless tasks. But most importantly, patients would have taper instructions communicated to them in a familiar and easy to follow format. Improved medication adherence is also a critically important in public health because it has been estimated that medication non-adherence costs $100-300 and in some instances can be directly related to premature death. Some taper calendar applications exist on the market, however, those are saddled with dated attachments to larger static databases and, therefore, are not viable options in the provision of a computerized taper calendar. The medical profession has failed to adopt them due to their lack of discretization, inaccessibility, incompatibility across platforms, and poor performance. Currently extant technology fails to provide the physician with both the option of an automatically generated taper and a taper that is able to be completely controlled and customized by the physician in terms of the specifics of the variation of medical doses. What is needed, therefore, is an application that is itself free standing that can quickly be ported to hospital computers and individual smartphones and other mobile devices without the cumbersome database and yet is capable of quickly transmitting all data related to the taper into all electronic medical record systems so as to be compatible with the current requirements of current medical practice. With this invention, physicians have the ability to prescribe tapers exactly as they see fit, even if the decrease in dose does not fit a smooth linear pattern. The invention herein described is that application which will save physicians from ever having to calculate a taper by hand or hand write a taper calendar again.

### OBJECT OF THE INVENTION

It is an object of this invention to provide physicians with an accessible computerized application that can easily create both automatically generated taper calendars that load quickly and with minimal effort all the information about the taper into the patient's medical record, facilitate the transmission of information about the drug to the prescribing pharmacist, and give the patient a calendar with specific, clear instructions with respect to how the patient will take the prescribed medications. Physicians that use the application do not have to compute or decide specific dates in which the application decrements in order to generate a taper, however a mode of use in which physicians can control exactly when the changes in dosage will occur.

Still other objects and advantages of the invention will in part be obvious and will in part be apparent from the specification and drawings.

### BRIEF DESCRIPTION OF THE DRAWINGS

FIG. 1: The screen the user sees when the user initiates the application

FIG. 2: The screen the user sees if the user chooses to use a non-linear taper

FIG. 3: The screen a user sees if the user chooses to use a linear taper

FIG. 4: The screen a user sees when the user adds a final non-linear phase to a linear taper

FIG. 5: The screen the application generates that shows the patient's taper calendar

FIG. 6: The screen the application generates to reflect the taper's temporal phases

FIG. 7: The screen the application generates to reflect prescription information

FIG. 8: The screen reflecting saved tapers

### DETAILED DESCRIPTION OF THE INVENTION

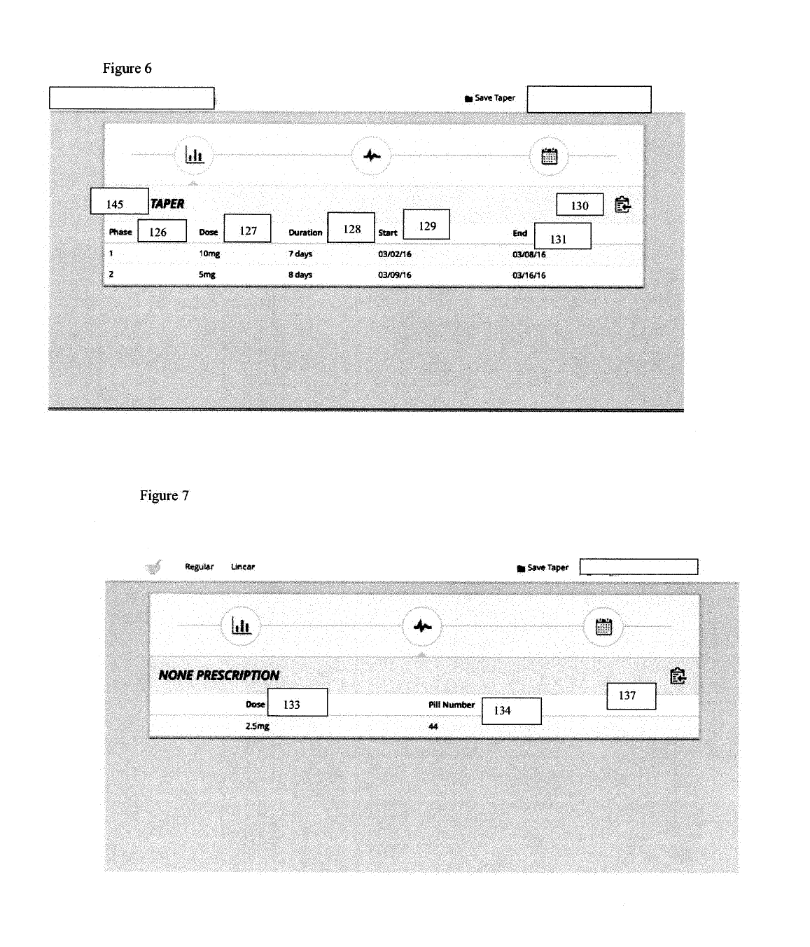

101: Login button that lets user access user's account
102: Button to redirect user to Taper inputs page
103: Button that lets user choose between linear and non-linear tapers
104: Start date input
105: Medicine Name input
106: Pill size input
107: Phase pane
108: Time and dosage output for corresponding phase
109: Durational input for corresponding phase
110: Button that removes phases when selected
111: Button that adds phases when selected
112: Button that causes the application to generate the taper when selected
113: Linear taper initial input dosage input
114: Linear taper final dosage input
115: Linear taper decrement quantity input
116: Linear taper duration input
117: Button that generates a final non-linear when selected
118: Non-linear taper phase input on a linear taper
119: Button that removes the final non-linear phase if selected
120: Button that saves taper if selected
121: Button that selects the taper result view that reflected in FIG. 6
122: Button that selects the taper result view that reflected in FIG. 5
123: Button that selects the taper result view that reflected in FIG. 5
124: Button that enables the user to input instructions in to the taper calendar and generate a printable version of the calendar
125: Calendar taper output
126: Taper phase output column
127: Taper dosage output column
128: Taper duration output column
129: Taper start date output column
130: Button that if selected saves the information that the taper outputs
131: Taper end date column
132: Patient name
133: Taper pill size column
134: Taper pill number column
135: Saved taper label
136: Saved taper start date
137: Button that if selected by the user saves the prescription information
138: Button that generates saved taper if selected
139: Button that deletes saved taper if selected
140: Phase result output
141: Second phase panel
142: Linear taper selection button
143 Linear taper input panel
144: Button that if selected generates a taper
146: Graphical and textual output which communicates to the patient how much medicine to take

### DETAILED DESCRIPTION OF THE PREFERRED EMBODIMENT

The taper application operates while connected to a database, which is generally but not necessarily an online database. The application allows users (medical professionals, generally physicians that prescribe medications) to quickly and easily generate medical tapers and prescribe medications that have variable doses.

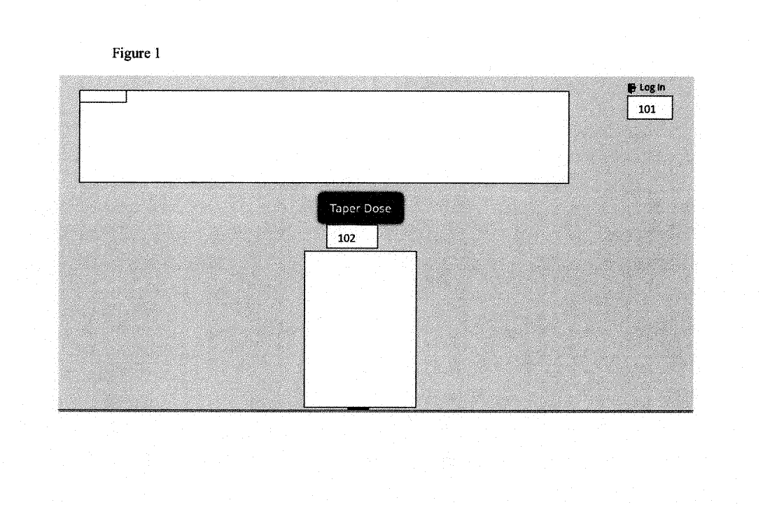

When the user enables the computer application, the user sees an initial graphical screen (FIG. 1). On the top right corner of the initial screen is the written text “Log In” (101). Selecting this text at any point allows the user to either log in to an existent user account where the user can access any tapers the user has saved, create an account where the user can save their tapers, or leave feedback to for the application's owner.

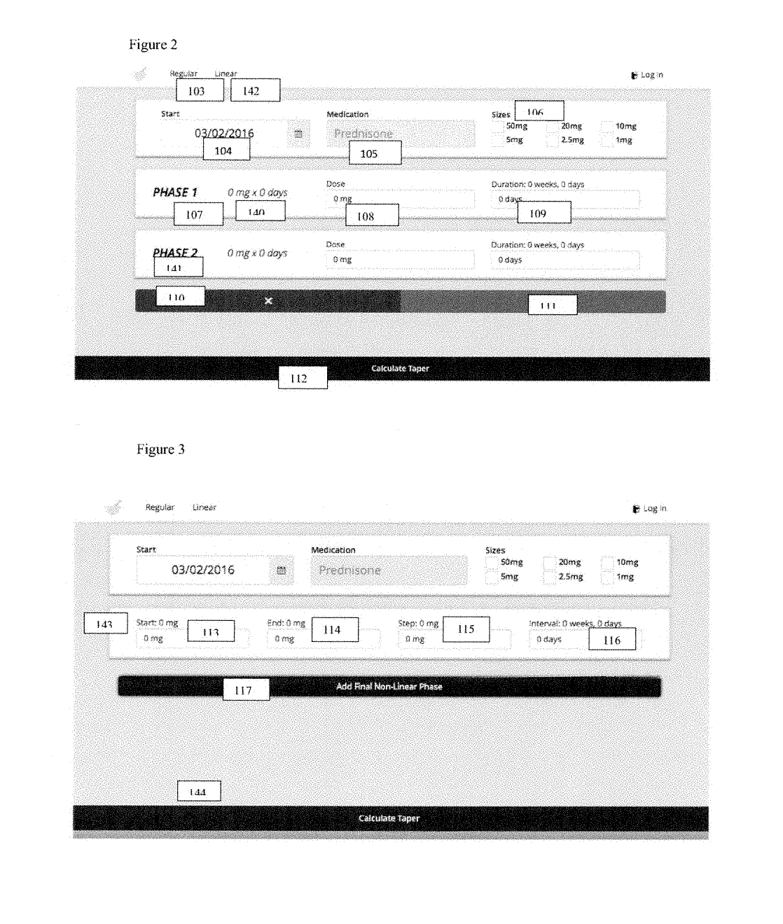

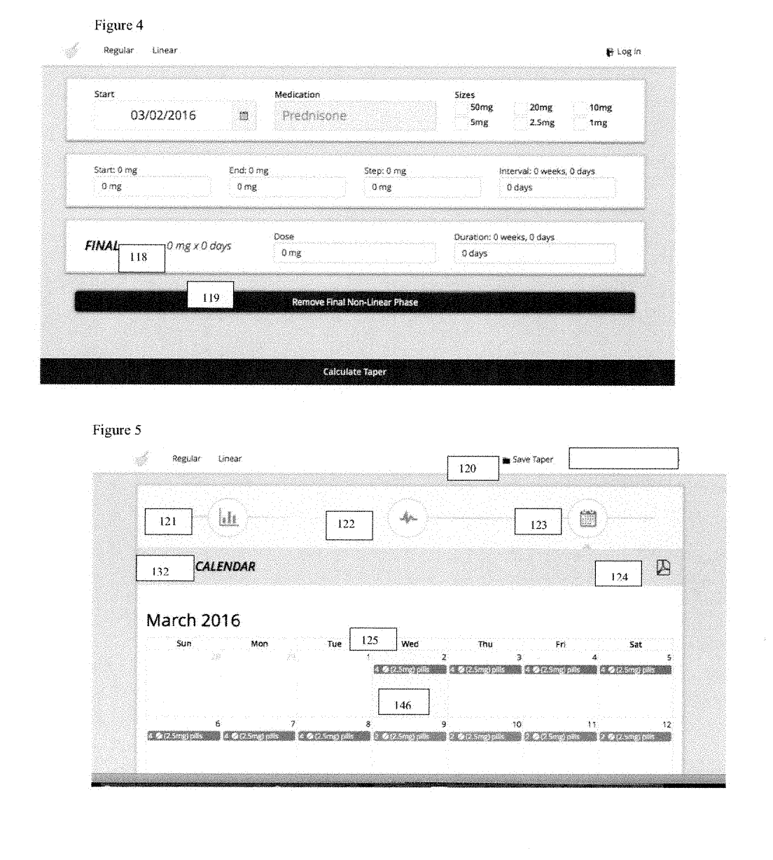

The application has a selectable graphical button in the center of the initial screen (102). If the user activates this button, the application redirects the user to a second screen (FIG. 2.) where the user will input the information necessary for the application to generate its output.

On the top left of the second screen are 2 selectable options (103), represented graphically by the words regular and linear. The words represent two different tapering methods, regular taper and linear taper. A regular taper gives the user complete discretion and control over when the different phases of medicinal administration will occur as well as their dosage at each phase. A linear taper allows the user to input an initial dose, a final dose, a duration, and a quantity by which the medicine will decrease over time. Once those inputs are entered, the application will compute a taper that decrements, or increments, by the entered medication dosage quantity. Linear taper calculations automatically decrement, or increment dosages at even temporal units over the duration of the medicinal administration.

The second screen defaults having the regular taper selected. Selecting the option “Linear” relocates the user to a third screen (FIG. 3). On the second screen, the user sees graphical input options. Just above the vertical center of the left side of the page is an input field (104) that includes both a calendar written in month, day, year format as well as a calendar icon. This calendar icon is selectable and is where the user selects the date at which the taper is to begin. The user may either enter the taper begin date by typing it or the user may select the interactive calendar icon, at which time a graphical calendar appears on the screen. The user may use the calendar to select the date upon which medicinal administration begins by selecting the corresponding date.

To the right of the start date input field (104) is medication name input field (105) which permits the user to enter the name of the medication to be tapered typographically. Though prednisone is in the graphical illustration of this pane, the use of the application is in no way limited to prednisone. Users may use it to generate a taper for any medication the patient needs.

To the right of the medication name input field (105), there is a group of check boxes (106) labeled “Sizes”. The user may select any of these boxes in order to communicate the application the size, or sizes, of the pills to be prescribed to the patient. Though the current embodiment interface has only a limited selection of pill sizes, this does not limit future embodiments of the application from using a more varied interface that would allow for greater user choice in pill size selection.

Directly beneath the start date input is a pane labeled “Phase 1” (107) characterized initially by an output with written the text “0 mg×0 days” (140). This output is subject to change by the user and is the graphical representation of the dose and duration of the relevant temporal phase of prescribed medicinal administration. To the right of the dose and days representation (140) is an input field labeled “Dose” (108) initially characterized by the characters “0 mg.” The user can change the “0” to a quantity of the user's choosing. Upon entering a quantity in the input field labeled “Dose” the numerical value will automatically be suffixed with the letters “mg”, representing milligrams. This in no way limits the application to prescribing medications only in milligrams, as other medications would default to their customary dosage units (for example micrograms or grams). It will also cause the aforementioned dose and days text output (140) to change to reflect the quantity of the dose the user inputs in the field (108). This output is the amount of medication the patient will take during the first temporal phase of the prescription period. Though the size and date measurements are given as milligrams and days, these do not limit the invention with respect to dosage size or administration periods. To the right of the dose input field (108) is another input field (109) labeled “Duration: 0 weeks, 0 days,” and an initial value that states “0 days” within the field. The user may input a numerical value in the duration input field (109) and for any number less than 7, the outputs, both above the duration box (109) and to the right of the “Phase 1” label (107), will update to the number entered by the user. For numbers greater than 7, the “weeks” output beside the duration label (109) increments each time the value entered is greater than any multiple of 7, with the number of multiples being the value of the of the “weeks” output and the remainder becoming the value of the days outputs above the duration box (109) and above the phase label (107).

Directly underneath the “Phase 1” pane (107) is a pane labeled “Phase 2” (141). The “Phase 2” pane is identical to the “Phase 1” pane in its form and function. The user inputs values for a phase of the taper in exactly the same fashion in which the user input values in the “Phase 1” pane. The user does so to input a second temporal phase of medicinal use scheduling that is entirely under the control of the user and is independent of the scheduling of the first temporal phase.

Underneath the “Phase 2” pane (141) on the second screen on the left is a graphical button marked with an “x” icon (110). Selecting this will delete the temporal phase with the highest value representing the most recent temporal medicinal phase. Located directly to the right of the button with the “x” icon is a graphical button with a “+” icon (111). Selecting this will add a graphical phase pane identical to the “Phase 1” and “Phase 2” panes that are generated automatically by the application (107, 141). This has the effect of giving the user complete control over the number of variable temporal medicinal phases, allowing them unlimited possibilities in delivering to patients' schedules that vary in their dosing instructions.

Beneath the Phase 2 panel (141) is a graphical button with the text label “Calculate Taper” (112). Selecting this button will cause the application to redirect the user to a graphical screen (FIG. 5) which is the initial output of the application's result based on the taper phases and their parameters. The initial view is the stepwise representation of the taper and its included phases with their specific parameters.

If from the second screen (FIG. 2), the user selects the linear option (142), the application redirects the user to a page with linear inputs for tapering the medication (FIG. 3). The linear page is identical to the regular page (FIG. 2) both in form and function from the user's perspective until in the center of the page, the user encounters a pane (143) calibrated to automatically generate a taper that decrements, or increments, in a linear fashion over time until the prescription medication is exhausted. This input has a text box (113) labeled with a text output “Start: 0 mg” and an initial value of 0 mg within the text box. This is an initial dosage the patient is to take when they begin using the prescription medication. The user enters a numerical value into this text box and the starting dosage will change to conform to the number of milligrams the patient is to take when the patient begins the treatment. To the right of the initial dosage text box (113) is another text box (114) with a text label and output that states “End: 0 mg” and an initial value within the text box that states 0 mg. The user here inputs a numerical value that will indicate the quantity of milligrams of medicine in the final dosage. Entering a numerical value within the textbox will update the output above to reflect the medication size the user wishes the patient to use at the end of the time of the medication administration. To the right of the text box with the ending dosage (114) is a text box (115) with a label above it initially characterized by the text “Step: 0 mg” and an initial text within the value “0 mg”. This value represents the amount by which the medication dose is to be decremented at each decrement point during the course of the medicinal administration duration. The user enters a value here to represent the decrement quantity which updates the value within and without the text box. To the right of the text box with the label “Step” (115) is another text box (116) with the label “Interval: 0 weeks, 0 days” above the text box. Within the text box is an initial value of “0 days”. Here, the user enters a numerical value. For numbers greater than 7, the “weeks” output above the interval text box (116) increments each time the value entered is greater than any multiple of 7, with the number of multiples being the value of the of the “weeks” output and the remainder becoming the value of the days outputs above the interval box. The interval text box input is temporal duration after which decrements of medicinal dosage occur. Using the linear option permits the use to automatically generate a taper without having to manually create a taper that changes at specific times and by specific amounts. Once the user chooses to calculate the taper, the application under this option will automatically generate an output that schedules the decrements according to the inputs the user entered.

Directly beneath the linear inputs panel (143) is a graphical button with the label text “Add Final Non-Linear Phases” (117). If the user selects this button, the application will generate a phase panel (118) identical to those displayed in the second application page (FIG. 2) except that it has a label which states “Final Phases”. This will enable the user to enter non-linear temporal medicinal administration phases that will assist in many situations, including but not limited to, where the user wishes instruct that the patient take medicine in certain doses not to be tapered beyond the period of the original decrement. If the user creates a final phase pane (118). At the bottom of the liner taper page (FIG. 3) is a selectable button (144) identical to the one (112) at the bottom of the regular taper page (FIG. 2) which has the same function.

Selecting the “calculate taper” button either on the regular or linear taper option redirects the user to an output page (FIG. 6). At the top right of the outputs page (120) is a selectable graphical button. If the user selects this button, the most recent taper is saved to their user account, as a database entry on the application's production database, for later access, whereby only a start date is needed to output the saved taper with different dates that adhere to the taper parameters specified in the original taper. This should not be construed as a limitation to the type of storage used. Beneath the save taper location and to the right are 3 circular graphical buttons side by side from left to right. The first (121), characterized by a bar chart if selected causes the taper result to display in its default form (FIG. 6). Selecting the second (122), which is characterized by a lifeline symbol, causes the application to display a screen (FIG. 7) designed to communicate the amount of medication to be prescribed as well as the pill size to a prescribing pharmacy. Selecting the third (123) causes the application to display a screen (FIG. 5) that is used to communicates to the patient via a graphical calendar how the patient is to administer themselves the medication.

On the left side of the page of each of the aforementioned 3 display screens (FIGS. 5-7) directly beneath their corresponding selection buttons (121-123) is text (145) that reflects the drug prescribed by the user. On the right side of the page in the same vertical position as the text (145) on two of the taper result screens (FIGS. 6-7) is locatcd a circular button with a clipboard graphic in its center (130). Selecting the clipboard graphic button copies the displayed text into the computer's clipboard so that the user can easily copy and paste the text into the electronic medical record system the user is using.

The default taper result screen (FIG. 6) is further characterized by 5 individually labeled columns (126-131) located directly beneath the name of the medicine (145). The first column (126) is labeled “Phase” and has space beneath it for row outputs generated by the application when the user calculates the taper. Those outputs reflect numerically each temporal phase of medicinal administration. The second column is labeled “Dose” (126) and reflects the amount of medication to be taken at each instance of administration by the patient for the phase in its corresponding row. The third column (127) is labeled “Duration” and reflects the time period of the temporal phase identified by its corresponding row. The fourth column (129) is labeled “Start” and reflects the start date of the temporal phase as inputted by the user. The fifth column 131) is labeled “End” and reflects the ending date of each temporal phase of the invention as inputted by the user.

Selecting the circular button with the lifeline icon redirects the user to a screen (FIG. 7) that reflects information to be used by the pharmacy that will fill the prescription. The screen is characterized by the same 3 display selectin buttons (121-123) that exist in the other 2 output screens as well as the medication name (145) and clipboard button (130) that also exist on the default screen. What differentiates the lifeline icon screen (FIG. 7) is that it has 2 columns, the first of which on the left (133) is labeled dose. This column (133) has an output space beneath it that is automatically filled by the application with the size of the pills or other medicinal delivery method that the pharmacist should use when filling the prescription. To the right of the first column is a second column (134) labeled “Pill Number”. The numerical values in that column communicate to the prescribing pharmacist how many pills the patient needs to fill the prescription.

Selecting the second circular button on the default screen (FIG. 6) redirects the user to a page (FIG. 5) where the application automatically outputs a graphical calendar (125) with a monthly grid format located directly underneath the drug name. Each grid square represents a day of the month. The calendar begins with the month selected by the user as the starting month during which the administration of the medicine will begin. The application automatically outputs graphical numerical outputs (146) into the daily grid squares defining the number and size of the pills that the patient must take in order to adhere to the requirements of their prescription. On the right side of the page at the same vertical level as the drug name is a button (124). If the user selects this button, the application will generate a printable calendar that the user can use to give the patient that will instruct the patient on the specific dose that he or she is to take on a given day. Furthermore, upon clicking the icon a modal window appears with a text input field that permits the user to enter instructions that will appear on the bottom of the first page of the calendar, giving users the ability to inform patients of information the user wishes the patient to have.

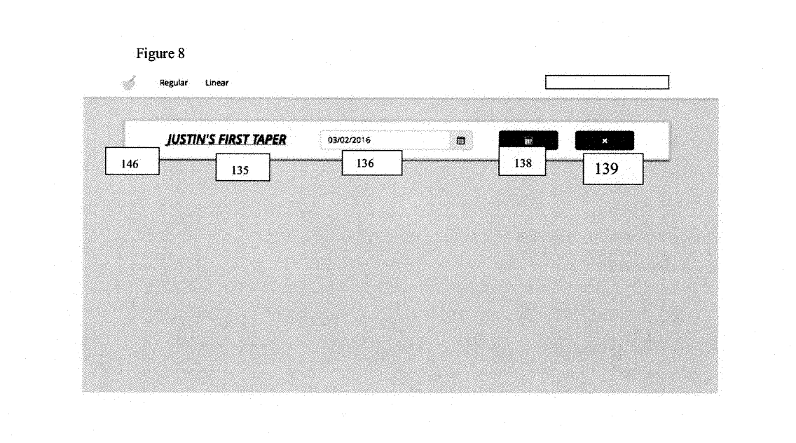

Selecting the save taper graphical button (120) allows a user to save any medicinal taper the user creates in the applications' database linked to the users account for future review, editing, or use. For example, a physician might have a specific taper that they prescribe for poison ivy. With this feature they would be able to bring up the parameters for their poison ivy taper each time a patient needed a steroid taper for poison ivy without having to enter the parameters manually each time. A graphical text box asks the user to name the taper and once the taper has been saved, the user may log into the user's account, hover over their account name and select a saved tapers option that pops out, and see the tapers they have saved on a screen (FIG. 8) that reflects the tapers that the user saved. They are listed in the format of a selectable pane with the name given to the taper (135) listed on the left of the pane. To the immediate right of the taper's name (135) is a calendar input (136) that reflects the date that medicinal administration is to begin and always defaults to the current date. To the immediate right of the calendar input (136) is a graphical button selectable button with a calculator icon (138) that will return the user to the initial screen generated after the taper was calculated (FIG. 6). To the right of the calculator button (138) is a button (138) labeled with an “x” icon (139) whose selection by the user will cause the application to delete the saved taper from the data base.

1: A method of generating printable medicinal tapers comprising the steps of accessing a computerized application, entering instructions into the application on how the medicinal taper is executed, receiving an output and the computerized application generates an output that reflects the medicinal taper.

2: The method of claim 1 wherein the user decides whether to first access an online account before entering instructions

3: The method of claim 2 wherein the computerized application gives the user a choice between an entirely discretized medicinal taper output and an automatically calculated linear taper output. If the user selects the discretized option, the user uses the application to generate a medicinal phase for each varying size of medicinal dosage, enters controls for each temporal phase of the taper by entering a starting date, duration and medicinal dosage for each temporal phase of medicinal duration. If the user selects a linear option, the user enters a beginning date, an ending date, a beginning medicinal dosage, and an amount which the medicine will increase or decrease at each increment decrement point, and a desired ending dose and the application automatically outputs a taper that decreases over time with each dosage stage having equivalent time duration and each increment or decrement quantity being identical.

4: The method of claim 3 where a user of the linear option may add final, non-linear phases of temporal medicinal administration that does not decrement by entering start date, duration, and medicinal dosage size after using the application after entering the information inputs for the linear phase of the medicinal taper

5: The method of claim 4 where a logged in user can save a taper at any time after using it once and the application generates a taper with newly specified dates without the user having to re-enter the dosage and time interval parameters.

6: The method of claim 5 where a logged in user can access any taper they have saved at any point once the user has logged in by selecting an option within the application to recall their saved tapers and selecting a saved taper. The application identifies each saved taper by a name given by the user and a start date for medicinal administration. Once the user recalls the taper, the user has the ability to edit dose, pill size, and dose intervals of the saved taper.

7: The method of claim 6 where the application generates an output with 3 selectable display options.

8: The method of claim 7 where selecting the first selectable display option causes the application to redirect the user to a screen output characterized by display of each temporal phase of the application, characterized by the phases' beginning dates, dose size, and duration of the phase in a text format. The screen output here further includes a selectable graphical button whose selection by the user causes the application to save the text of the temporal phase display, generally on the computer's clipboard.

9: The method of claim 8 where selecting the second selectable display option causes the application to redirect the user to a screen output characterized by a display of the pill or other delivery method volume and the number of instances of the pill or other delivery method the patient will need. The screen output here further includes a selectable graphical button whose selection by the user causes the application to save the text of the temporal phase display.

10: The method of claim 9 where if the user selects the third display option, the application redirects the user to a screen with a graphical calendar with daily sequential outputs for each date of medicinal administration. Each medicinal administrate has a graphical icon denoting whole or half size, and when the patient is to receive medication and specific instructions written in text instructing the patient how much medicine to take. At the bottom right of each calendar page is a legend corresponding to the whole and half graphical icons which further provides written instructions dictating whether the pill is to be halved or taken whole. The first page of the printable document has the phases of the taper with their associated dose, duration, start date, and end date

11: The method of claim 10 where first screen further contains the date the printable calendar was generated and a blank line to physically write in the patients name, and also an option that, if selected by the user, allows the user to enter any additional instructions the user wishes with a notice not to include identifying patient information.. Once the user either enters those instructions or declines to enter instructions, the application generates a copy of the taper calendar in a printable format.

12: The method of claim 11 where the application's third screen the option to generate a calendar file with the taper information in a format compatible with corresponding calendar software common to computer operating systems so that the user can give the patient an electronic taper calendar file that the patient can use on any of the patient's personal computing devices.

13: The method of claim 12 where the application generates an alphanumeric text string upon compiling the taper. The user would then have the option to transfer said text string to a corresponding patient. The application here would have a feature for patients to enter their text strings and access their tapers directly from the application.
